(19) United States
(12) Patent Application Publication
(10) Pub. No.: US 2025/0356377 A1
(43) Pub. Date: Nov. 20, 2025

(54) SYSTEMS, APPARATUSES, AND METHODS OF AUTHENTICATING SIGNED ITEMS

(71) Applicant: Genuine Inc., San Ramon, CA (US)

(72) Inventor: Chris Savarese, Danville, CA (US)

(21) Appl. No.: 19/207,225

(22) Filed: May 13, 2025

Related U.S. Application Data
(60) Provisional application No. 63/648,014, filed on May 15, 2024.

(51) Int. Cl. G06Q 30/018; G06K 7/14

(52) U.S. Cl. CPC G06Q 30/0185; G06K 7/1417

(57) ABSTRACT

An authentication system and method of authenticating a signed item captures a first image of a unique code on a physical item at a first time of a session. A session image of a participant affixing a signature to the physical item during the session is captured. The system and method captures a second image of the signature and the unique code on the physical item at a second time of the session. An authentication asset is generated including the unique code superimposed on one or more of the first image, the session image, or the second image. Other embodiments are described and claimed.

This application claims priority to, and the benefit of, U.S. Provisional Patent Application Ser. No. 63/648,014, filed May 15, 2024, the entire contents of which is hereby incorporated by reference.

### BACKGROUND

### Field

The present disclosure relates to systems, apparatuses, and methods used to authenticate items. More specifically, the present disclosure relates to an authentication system and method useful for authenticating signed items, such as physical items signed by a participant at a signing event.

### Background Information

Fraud is a significant problem in the world of physical collectibles. For example, signed physical items, including photographs signed by a celebrity at a signing event, may be forged. Further, authentication services based on “eyewitness account” or “expert opinion” are susceptible to fraud. To authenticate a signed physical item, third-party authentication services are used. Such services employ human authenticators to observe and analyze a signature (at a signing event or afterward) and to then apply or provide a label of authentication that provides confidence to a buyer that the signed physical item is authentic and, therefore, valuable. Another common practice related to authenticating signatures is “expert opinion.” With expert opinion authentication, trust is placed in a third party that the third party is knowledgeable enough about the appearance of a certain signature to determine if a given signature is authentic or fake. This practice is highly subjective and seen by many as not reliable or accurate in many cases. Third-party authentication can involve the human authenticator generating a video recording of the signing event and using the video recording as proof of signature.

### SUMMARY

Existing methods of authenticating signed items are costly and vulnerable to fraud. The use of third-party authentication services can be both monetarily expensive and can create logistical friction that may make signing events cost prohibitive or difficult to organize and run. For example, it is common for a memorabilia store to offer its customers a signing event where celebrities are present to sign autographs. The memorabilia store must coordinate a third-party authentication service to arrive and be present for the event. This introduces additional expense, logistics/planning, and risk (e.g., risk that the authenticator is not present or on time for the event).

The use of video recordings made and stored by third-party authentication services has similar expense and logistical difficulties and, to date, authentication videos are not effective because they do not create an association between the video proof and the individual item(s) being signed. For example, if a signing event is captured on video, it is difficult or impossible for the buyer of a signed item to prove that the item itself was signed-currently videos and photos merely capture the person signing at the event. A need exists for an authentication system and method of authenticating signed items that does not require a third-party authenticator and, therefore, can facilitate signing events that run smoothly and inspire confidence in the authenticity of items signed at such events. Furthermore, a need exists to create a system that authenticates items in a way that does not rely on expert opinion or eyewitness account.

In an embodiment, a method of authenticating a signed item is provided. The method includes capturing, by one or more cameras of an authentication system, a first image, e.g., a beginning image, of a unique code on a physical item at a first time, e.g., a beginning, of a session. The method includes capturing, by the one or more cameras, a session image of a participant affixing a signature to the physical item during the session. The method includes capturing, by the one or more cameras, a second image, e.g., an end image, of the signature and the unique code on the physical item at a second time, e.g., an end, of the session. The method includes generating, by one or more processors of the authentication system, an authentication asset including the unique code superimposed on one or more of the first image, the session image, or the second image.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings.

FIG. 1 is a flowchart of a method of authenticating a signed item, in accordance with an embodiment.

FIG. 2 is a pictorial view of a first image captured by an authentication system, in accordance with an embodiment.

FIG. 3 is a pictorial view of a session image captured by an authentication system, in accordance with an embodiment.

FIG. 4 is a pictorial view of a second image captured by an authentication system, in accordance with an embodiment.

FIG. 5 is an overhead pictorial view of a one-person, medium-throughput system and apparatus for authenticating signed items, in accordance with some embodiments.

FIG. 6 is a perspective view of a one-person, medium-throughput system and apparatus for authenticating signed items, in accordance with some embodiments.

FIG. 7 is an overhead pictorial view of a one-person, medium-throughput system and apparatus, with an optional additional camera, for authenticating signed items, in accordance with some embodiments.

FIG. 8 is an overhead pictorial view of a two-person, high-throughput system and apparatus for authenticating signed items, in accordance with some embodiments.

FIG. 9 is an overhead pictorial view of a two-person, medium-throughput system and apparatus for authenticating signed items, in accordance with some embodiments.

FIG. 10 is an overhead pictorial view of a two-person, low-throughput system and apparatus for authenticating signed items, in accordance with some embodiments.

FIG. 11 is an overhead pictorial view of a three-person, high-throughput system and apparatus for authenticating signed items, in accordance with some embodiments.

FIG. 12 is an overhead pictorial view of a four-person, high-throughput system and apparatus for authenticating signed items, in accordance with some embodiments.

FIG. 13 is a block diagram of an example computing device that may perform one or more of the method operations described herein, in accordance with some embodiments.

### DETAILED DESCRIPTION

Embodiments describe authentication systems, apparatuses, and methods of authenticating signed items. The authentication systems, apparatuses, and methods may, however, be used to authenticate other interactions with the item, such as another type of marking. Thus, reference to the affixation of a signature to the item is not limiting.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

In an aspect, an authentication system and method of authenticating a signed physical item includes capturing images of a session in which the physical item is signed, and generating an authentication asset based on such imagery. For example, images of the physical item may be captured at three instances, e.g., a beginning, during, and at an end, of the session. The images may include a unique code on the physical item that can be superimposed on the images in the authentication asset. Accordingly, the authentication asset can provide proof that the physical item having the unique code, which may be viewed by an owner (e.g., an initial buyer) or a prospective secondary buyer, was the same item that was signed during the session. The authentication system and method can place the signer, the initial buyer, and the prospective secondary buyer in control of the authentication process without involving a third-party authenticator. For example, the signer may use their own mobile device to perform the authentication process without involving such third-party authenticator.

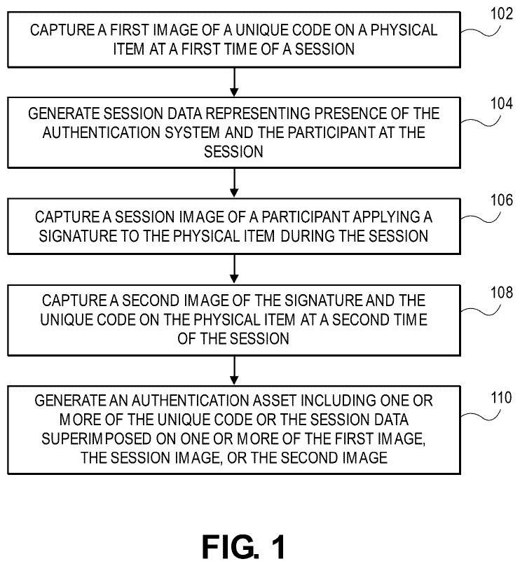

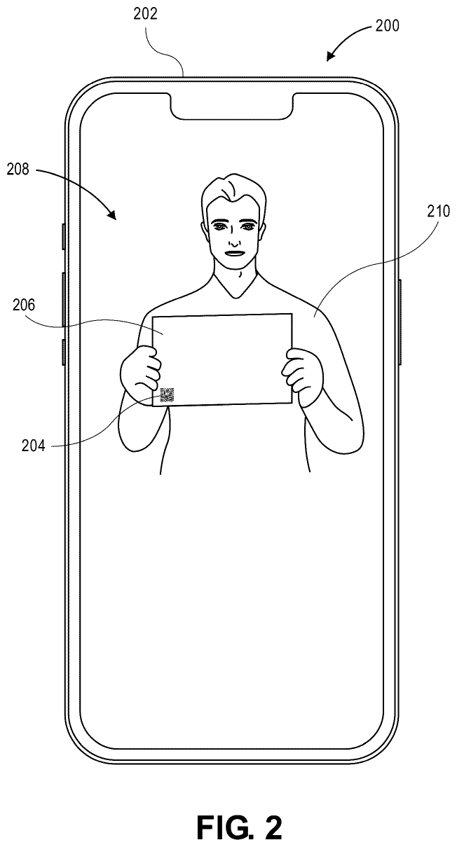

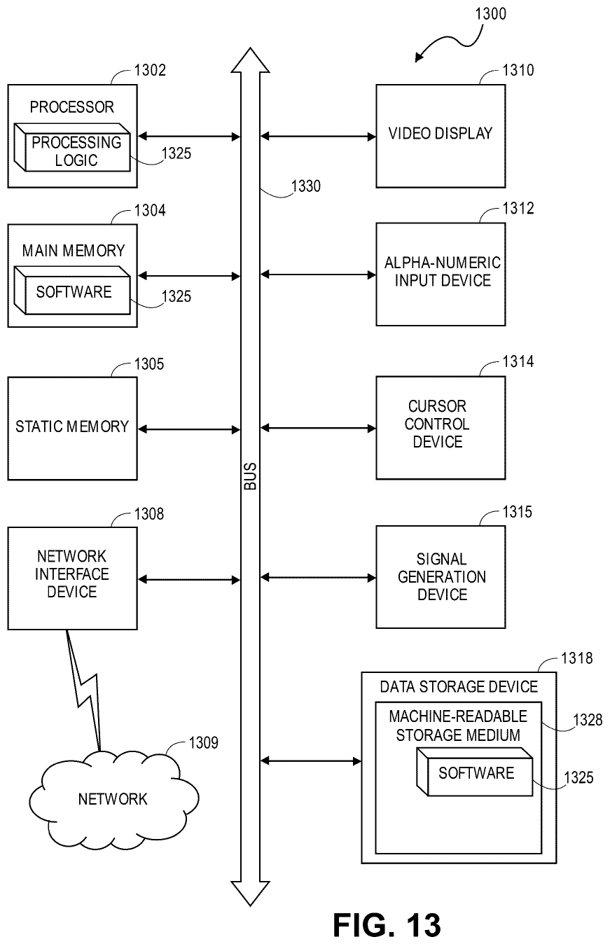

Referring to FIG. 1, a flowchart of a method of authenticating a signed item is shown in accordance with an embodiment. The method can be performed by an authentication system. For example, the authentication system can include one or more components, which may be co-located, e.g., in a same device housing, or in communication with each other through a network. By way of example, the authentication system can include a mobile device networked with an authentication server. More particularly, each of the components can be components of a computing system or a computing device (FIG. 13) capable of communicating data to other components in the system. In an embodiment, the authentication system includes one or more cameras and one or more processors to perform the method operations described below. The operations can include generating an authentication asset that provides proof that an item was present and/or signed during a session, such as a signing event. Accordingly, the authentication asset can be transmitted to and stored on a data storage server for future access and proof. For example, a client device, e.g., a computer of a system user, may access the authentication asset stored on the data storage server through a network to provide proof of authenticity of the signed item, which the consumer may have purchased (or may plan to purchase) as memorabilia. The method operations shown in FIG. 1 correspond to the pictorial views of FIGS. 2-4. Accordingly, the operations of FIG. 1 are referred to below in the description of FIGS. 2-4.

Referring to FIG. 2, a pictorial view of a beginning image captured by an authentication system is shown in accordance with an embodiment. In an embodiment, the authentication process can be initiated by scanning a unique code 204 on a physical item 206. For example, a participant 210 can scan the unique code 204 using a software application running on a mobile device of an authentication system 200 and, in response to the scanning, the software application may initiate prompts to guide the participant 210 through the authentication process. By way of example, the prompts can lead to operation 102 by prompting the participant 210 to begin recording a video of the signing session. Alternatively, the software application may cause video capture to begin immediately in response to the scanning of the unique code 204, without requiring user intervention. In yet another example, the video capture of the participant 210 signing a tagged/coded item may occur before (and in the same, continuous video of) the recording of the unique code 204 on the tagged item.

At operation 102, one or more cameras 202 of the mobile device of the authentication system 200 capture an image of the unique code 204 on the physical item 206. The image can be a first image 208, captured at a first time of a session. For example, the first image 208 can be a beginning image captured at a beginning of the session. The session can be a signing session in which the participant 210, e.g., a celebrity, signs the physical item 206, e.g., a photograph, for a fan. Alternatively, the physical item 206 can include other memorabilia, such as sporting goods, clothing, etc.

Additional utility of unique code 204 is for the end user/consumer of the signed item. Once the signed item is purchased, the consumer can scan or tap their phone against the unique code 204 and: 1) register their purchased signed item (e.g., by providing their name and contact information), or 2) be directed to a website that displays the authentication video of the person signing the item. The website may contain other content related to the person signing the item and/or the item itself.

The unique code 204 may be added to the physical item 206 prior to the interaction. For example, a label having a matrix barcode, e.g., a quick-response (QR) code, can be applied to the physical item 206 prior to the participant 210 arriving at the signing session, or just before the signing occurs. In any case, the physical item 206 can be an object that the participant 210 is expected to interact with and, accordingly, the unique marking can be applied to the object prior to the interaction.

Optionally, the first, e.g., beginning, image 208 can include both the physical item 206 and the participant 210. For example, the beginning image 208 may be an image of the participant 210 holding the object up to the camera(s) 202 to allow a face of the participant 210 and the unique code 204 to be simultaneously imaged.

In an embodiment, at operation 104, the authentication system 200 generates session data representing the session. The session data can be generated when images are captured by the camera 202. The session data can include one or more of time data or location data associated with the session and, more particularly, a timestamp and/or a Global Positioning System (GPS) location of the mobile device at a time when images are captured by the camera 202. More particularly, one or more processors or sensors of the authentication system 200 can generate location data (e.g., a GPS sensor), time data (e.g., a clock), or other event-based data that can be associated with the session and/or the unique code 204 captured from the physical item 206 at the session.

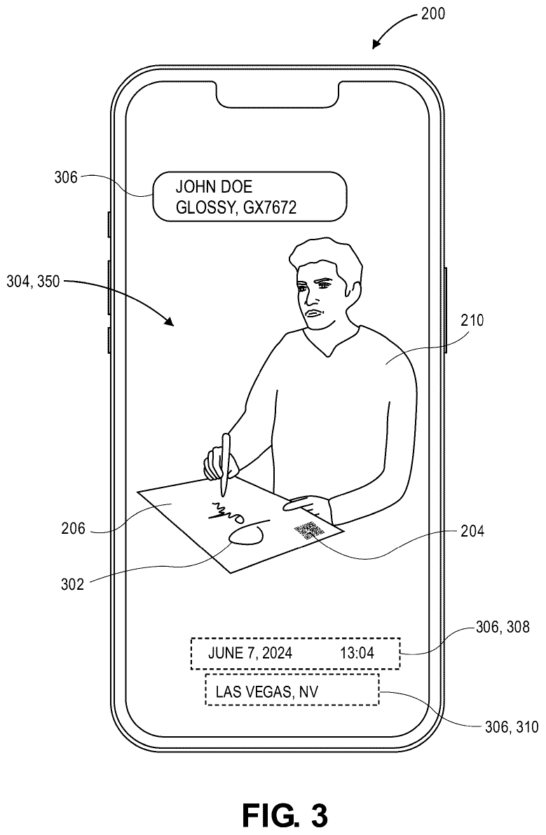

Referring to FIG. 3, a pictorial view of a session image captured by an authentication system is shown in accordance with an embodiment. At operation 106, the one or more cameras 202 of the authentication system 200 capture an image of the participant 210 affixing a signature to the physical item 206. The image can be a second image 304 taken during the session. Accordingly, the image may be a session image 304.

It will be appreciated that the signing process is one mode of interaction between the participant 210 and the physical item 206. Other interactions are contemplated. For example, the participant 210 can etch or make other markings on the physical item 206. In any case, the authentication system 200 can authenticate the item as being the object of the interaction by the participant 210. More particularly, the session image 304 can capture the interaction between the participant 210 and the physical item 206 during the session.

The session image 304 may be associated with respective session data 306. For example, as described above, the mobile device of the authentication system 200 can generate identifying information, such as time data 308 and/or location data 310 associated with the session, which verifies that the participant 210 interacted with the object at a particular time and place. In the illustrated example, the participant 210 is signing the physical item 206 pre-tagged with the unique code 204 on Jun. 7, 2024, at 1:04 P.M. in Las Vegas, NV.

The session data 306 can also include the unique code 204, participant 210 data, and/or object data identifying the specific participant 210 and item that are the subject and object of the interaction. For example, the participant 210 data can include a name of the participant 210, e.g., John Doe, and the object data can include a description of the physical item 206, e.g., a “Glossy” (photograph), accompanied by the unique code 204, e.g., GX7672, affixed to the physical item 206.

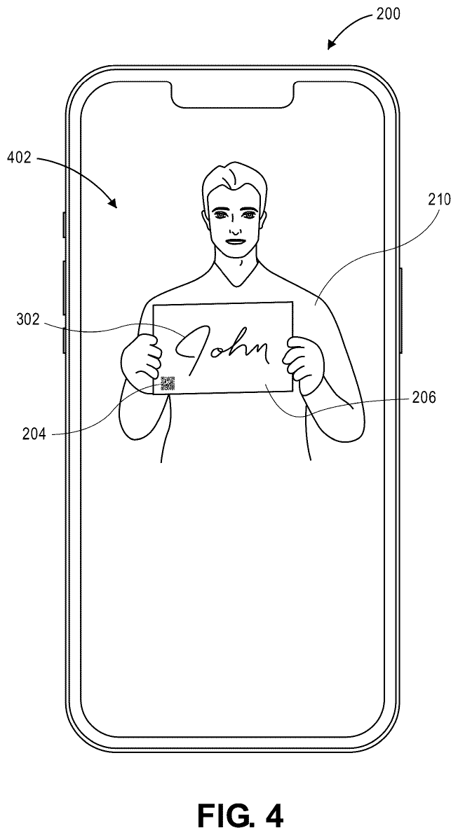

Referring to FIG. 4, a pictorial view of an end image captured by an authentication system is shown in accordance with an embodiment. At operation 106, the one or more cameras 202 of the authentication system 200 capture an image of the signature and the unique code 204 on the physical item 206. The image can be a second image 402 taken at a second time of the session. For example, the second image 402 can be an end image taken at an end of the session. The second, e.g., end, image 402 may include, in addition to the co-affixed signature and unique code 204, the participant 210. For example, the end image 402 can be an image of the participant 210 holding the signed physical item 206 up to the camera(s) 202.

In an embodiment, the end image 402 may cause video capture to end. For example, in response to determining that the end image 402 contains both the signature and the unique code 204, the software application may terminate video recording. The recorded video may be stored and/or used to generate an authentication asset 350, as described below.

It will be appreciated from the description above that actions taken by the signer can cause the authentication system 200 to perform responsive operations. For example, as described above, scanning the unique code 204 can cause the authentication system 200 to initiate video capture. In an embodiment, the responsive operation may include terminating video capture. For example, the participant 210 may scan the unique code 204 after signing the item and, in response, the authentication system 200 can stop capturing video after a predetermined period of time. Optionally, after the predetermined period of time elapses, a new video recording may begin. For example, the process may revert to operation 102 to capture the signing of a next item by the participant 210 (e.g., a next photograph in a stack of photographs).

At operation 110, one or more processors of the authentication system 200 generate the authentication asset 350. The one or more processors may be housed in the mobile device or, alternatively, may be part of an authentication server networked to the mobile device. The authentication asset 350 includes one or more of the beginning image 208, the session image 304 or the end image 402. For example, referring again to FIG. 3, the authentication asset 350 can include the session image 304 having the unique code 204, e.g., GX7672, superimposed on the image. The authentication asset 350 may include additional session data 306 superimposed on the image. For example, the time data 308 and/or the location data 310 can be superimposed on the image. The session data 306 may also include the participant 210 data and the item data, optionally grouped with the unique code 204 within a same border. The authentication asset 350 therefore provides proof of the interaction accompanied by captured data, both image data and text data, identifying and/or describing the interaction.

It will be appreciated that, although the terms “beginning image,” “session image,” and “end image” are used above, the images may be taken at different times relative to the signing of the physical item 206. For example, the “beginning image” may be taken before or after the item is signed. In an embodiment, a tag may be applied to an item to be signed, a video recording of the person signing the object may be made first, and then a video recording of the tag/code on the item may be made second. That is, the order of operations may be changed, e.g., reversed, in certain embodiments. Accordingly, temporal indicators are provided with respect to the timing of certain embodiments, but such indicators are not intended to be limiting.

An example of a use case of the innovation described herein is an application for trading cards. Trading cards are popular collectible items and there are variations of signed trading cards. For example, there are on-card autographs, or “hard-signed,” trading cards and sticker autographs, or “sticker autos,” trading cards.

On-card autograph trading cards are directly signed by an athlete or personality directly. The autograph is affixed directly to the surface of the trading card itself. These are often considered the most desirable by collectors because the signature is directly on the card.

Sticker autograph trading cards include a signature obtained on a sticker or label, which is then adhered to the trading card. While still containing an authentic signature, some collectors value these slightly less than on-card autographs because the signer did not physically handle the card. With the invention described herein, a consumer of a signed trading card that has been authenticated by the means described herein, can interact with a tag including a unique code 204 that may be adhered to the back of the trading card. This interaction can allow the consumer to “register” or claim ownership of the trading card and be directed to a webpage that displays the authentication video showing the card being signed (and other pertinent content).

In addition to on-card and sticker autographs, some trading cards include “patches” or cut up pieces of items worn by people (e.g., a game-worn baseball jersey or an MLB debut patch). It is contemplated that a trading card that includes the authentication technology described herein may also incorporate the technology described in U.S. patent application Ser. No. 18/634,791, filed on Apr. 12, 2024, and titled “System And Method of Generating Authentication asset 350 Using Radio Frequency Identification And Event Data,” the contents of which are incorporated herein by reference, whereby a patch can be configured to include a combination of long-range RFID and short-range (e.g., NFC) or barcode (e.g., QR) technologies, such that a patch could be attached to an item to be used in an event prior to the event, then authenticated during the event, using methods described herein and in U.S. patent application Ser. No. 18/634,791. After the event, the patch could then be removed from the event-used item and incorporated into the trading card. In this way, consumers could interact with the trading card using their phone and be directed to registration, authentication video(s), and/or other content as described herein.

The authentication asset 350 may be stored in memory of the authentication system 200, e.g., at the authentication server, for access by an owner or potential buyer of the physical item 206. In an embodiment, the authentication asset 350 may be stored, e.g., on blockchain. For example, the physical item 206 may be owned by a fan of the participant 210 who purchased and took possession of the physical item 206 after the session. The owner may scan the unique code 204 using, e.g., a camera 202 of a mobile device running a software application, and the software application can access, based on the scanned code, the authentication asset 350. For example, the authentication asset 350 may be rendered for viewing on the mobile device to allow the owner to view the recorded interaction. Accordingly, the owner has the physical asset and an accompanying digital asset that verifies the authenticity of the physical asset. Similarly, a potential buyer of the physical item 206 can scan the unique code 204 to view the authentication asset 350 and therefore be assured that the physical item 206 is authentic, i.e., that the physical item 206 is the same item that was signed by the participant 210 during the session. The authentication asset 350 therefore acts as a certificate of authenticity that can be accessed by scanning the unique code 204 that is pre-tagged on the physical item 206.

The authentication asset 350 may be a presentation-grade version of the authentication asset, which can be stored on blockchain. The authentication asset 350 can provide proof that the item was signed at the event. In an embodiment, the authentication asset 350 may also be stored, e.g., on blockchain, for access, to confirm authenticity of the authentication asset and/or item. For example, an asset showing several item tag codes can be stored on blockchain, and may be accessed by a user to compare against the authentication asset 350. Comparison of the authentication assets, including information captured and associated with both authentication assets, can verify the authenticity of the item as being signed at the event.

In one embodiment, the authentication asset 350 is an NFT stored on Blockchain. It is contemplated that the asset (e.g., NFT) may include a “authentication asset” as described herein and other information describing the event, the event items, and event data. In a preferred embodiment, an NFT includes an event authentication asset, additional information about the authenticated event physical item, and the NFT serves two primary purposes. The first purpose is to serve as digital proof of authenticity, the second purpose is to serve as a means of ownership tracking, like a deed or a title certificate for property. In an embodiment, the NFT can be generally referred to as “digital title” and more specifically as a Digital Title Certificate. The NFT can include the word “Title” on it along with words conveying authenticity such as “Genuine Certified” or “Certified Genuine.” It is contemplated that the digital title that may be stored on Blockchain can provide links or a code (such as a scannable QR code) so that users can scan the digital title and be directed to a website with additional content related to the physical item 206.

The authentication asset 350, e.g., a video file, may be encrypted or use verifiable credential and Blockchain technology to prevent the potential of fraudulent “deepfake” videos being used. With the emergence of AI and “deepfake” technology, it will be important for potential users of the system to know the video is authentic. The video file captured in the software application may be associated with metadata (time, location, etc.) and may be encrypted or otherwise tagged. Using verifiable credential technology or similar, the video file recorded in the software application will be stored in a database/Blockchain in a manner such that it will be evident that the video file was uploaded directly to the database (and was not tampered with by any other software or system between the time of recording and being uploaded to the database). The authenticated video file may have data superimposed over the video file including date of video, time, logo or marking indicating the video is authentic, etc.

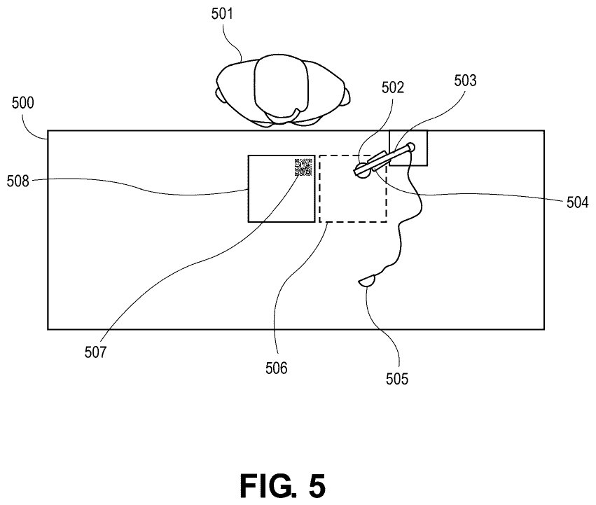

Referring to FIG. 5, an overhead pictorial view of a one-person, medium-throughput system and apparatus for authenticating signed items is shown. In this embodiment, a person signing 501 is positioned in front of a table or flat surface 500. An apparatus is positioned on table 500, consisting of a QR indicator 502. The QR indicator may be an audio and/or visual cue for the signer that a QR code has been successfully scanned. For example, the QR indicator 502 can include a light to shine, or a speaker to buzz, when scanning of the unique code is successful. It should be understood that the unique code may be a QR code or may be included in another type of tag technology (e.g., bar code, NFC, Data Matrix, etc.) and the QR indicator may be an indication of successful scanning of unique codes affixed to items to be signed, regardless of the technology presenting the unique code.

A bar code reader 503 may be positioned facing down to the area for the item to be scanned 506. A camera 504 may also be positioned facing down to the area where the tagged item may be scanned and photographed. A video camera 505 (e.g., webcam, etc.) is positioned facing the person signing the item to capture the front side of the person signing, including their face if possible. An item to be signed 508 has a unique code 507 affixed to it.

The process or method for a one-person, medium throughput signing may include the following operations. At an operation, a unique code 507 can be affixed to the item to be signed 508 prior to the signing session. At an operation, the person signing 501 initiates a signing session. This may be done using a mobile app (as described above). In an embodiment, the initiating of the signing session powers on indicator 502, bar code reader 503, camera 504, and causes video camera 505 to start recording video. In an embodiment, at an operation, the person signing 501 signs the tagged item 508 while being recorded by video camera 505. After signing, the person signing 501 slides the tagged item 508 to the area to be scanned 506. When the bar code scanner 503 successfully scans the unique code 507, the indicator 502 provides audio and/or visual confirmation of successful scan and the camera 504 may be prompted to capture a photograph of the signed item. At an operation, after camera 504 captures a photograph of the signed item 508, the person signing 501 moves the signed item 508 outside of the scanning area 506.

When the person signing 501 begins the process of signing the next item to be signed 508, it should be understood that actions of bar code reader 503 and/or camera 504 may trigger the starting and stopping points for the video being captured by video camera 505. In an embodiment, the order of the actions described above may be changed. For example, it may be beneficial for the person signing 501 to scan the item 508 first, then sign the item, then position the item back to area 506 so that camera 504 can capture a photo of the signed item. In other words, there can be various configurations of the method, to optimize the process.

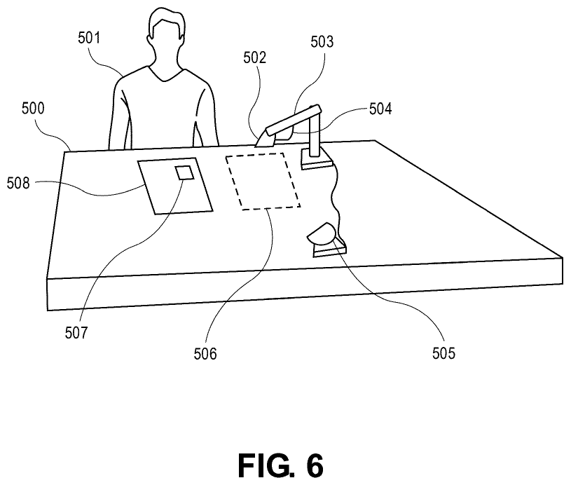

Referring to FIG. 6, a perspective view of the one-person, medium-throughput system and apparatus for authenticating signed items described in FIG. 5 is shown. The perspective view includes the system components described above with respect to FIG. 5, and the system and method of operation may be identical thereto. Relative orientations and positions of the system components is shown in FIG. 6, such as the potential relative vertical position of the components.

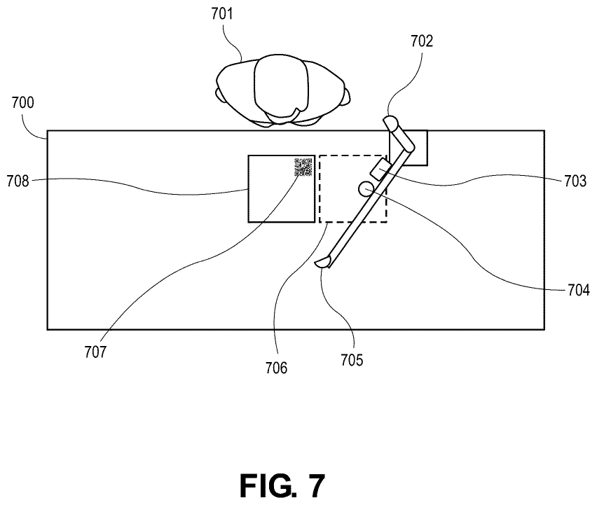

Referring to FIG. 7, an overhead pictorial view of a one-person, medium-throughput system and apparatus (with optional additional camera) for authenticating signed items is shown. The method and apparatus in FIG. 7 is the same as those described in FIG. 5. With the addition of another camera 702 configured to record video of the item being signed 708 while it is being signed. In other words, camera 702 records the hand of the person signing 701 while signing. Numerals of corresponding components between FIG. 5 and FIG. 7 correspond to each other. For example, bar code reader 502 corresponds to bar code reader 702, camera 503 corresponds to camera 703, and so on. It will be apparent to one skilled in the art that the correspondingly numbered system components are interchangeable.

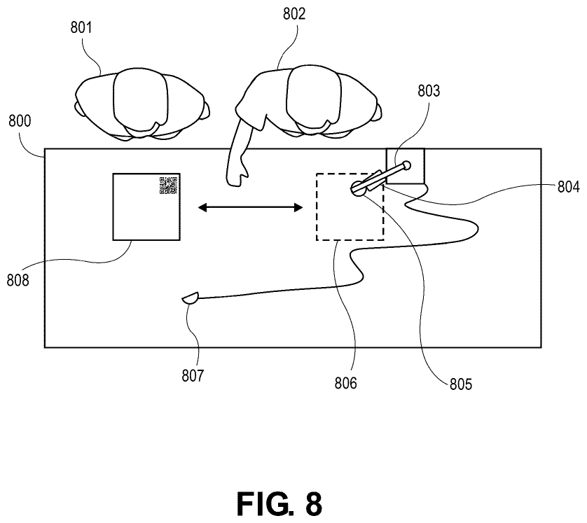

Referring to FIG. 8, an overhead pictorial view of a two-person, high-throughput system and apparatus for authenticating signed items is shown. In an embodiment, to not slow down the signer 801, a person scanning 802 is added to the process. The details of the process depicted in FIG. 8 are the same as those described in FIG. 5. The difference is a signer 801 can focus on signing items 808 while a person scanning 802 handles the item signed either before or after the person signing 801 signs item 808.

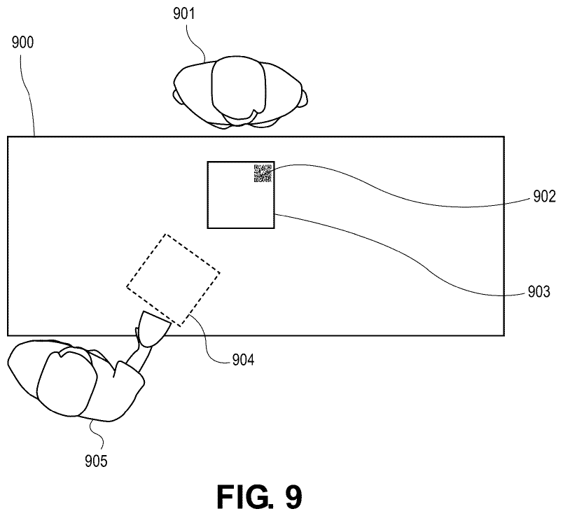

Referring to FIG. 9, an overhead pictorial view of a two-person, medium-throughput system and apparatus for authenticating signed items is shown. In this configuration, a person signing 901 is positioned in front of a table 900, and an item 903 with an affixed unique code 902 is positioned in front of the signer 901. A person with a combination handheld bar code reader and camera captures video of signing, scans code and captures video and still image of signed item in a scanning area 904. This embodiment requires a relatively expensive combination scanning and camera device, operated by person scanning 905 and provides moderate/medium throughput.

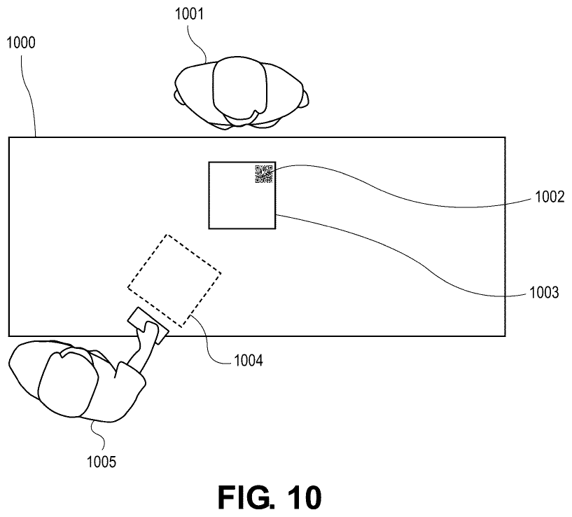

Referring to FIG. 10, an overhead pictorial view of a two-person, low-throughput system and apparatus for authenticating signed items is shown. In this configuration, a person signing 1001 is positioned in front of a table 1000, and an item 903 with an affixed unique code 1002 is positioned in front of the signer 1001. A person with a software application running on a mobile device 1005 captures video of signing, scans code and captures video and still image of signed item. This embodiment requires a relatively inexpensive and more common and readily available device (e.g., a smartphone), operated by the person scanning 1005 and provides low throughput.

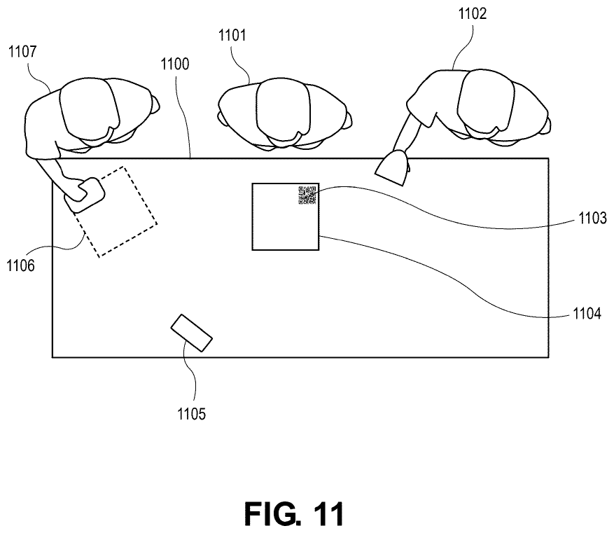

Referring to FIG. 11, an overhead pictorial view of a three-person, high-throughput system and apparatus for authenticating signed items is shown. In this configuration, a person signing 1101 is positioned in front of a table 1100, and an item 1104 with an affixed unique code 1103 is positioned in front of the signer 1101. A person with a handheld bar code reader 1102 scans code 1103. A person with a phone or camera 1107 captures still images of signed items in an area for photographing 1106. A phone or camera 1105 mounted on the table, e.g., with a tripod, etc., can be configured to capture video, and the starting and stopping of the video may be triggered by the scanning and/or photographing actions. This embodiment requires three people and can be performed using relatively inexpensive and more common, and readily available, devices (such as smartphones). The method provides high throughput. It should be understood that the person doing the scanning 1102 in the configuration could also use a smartphone instead of a bar code scanner. The bar code scanner may provide slightly better throughput.

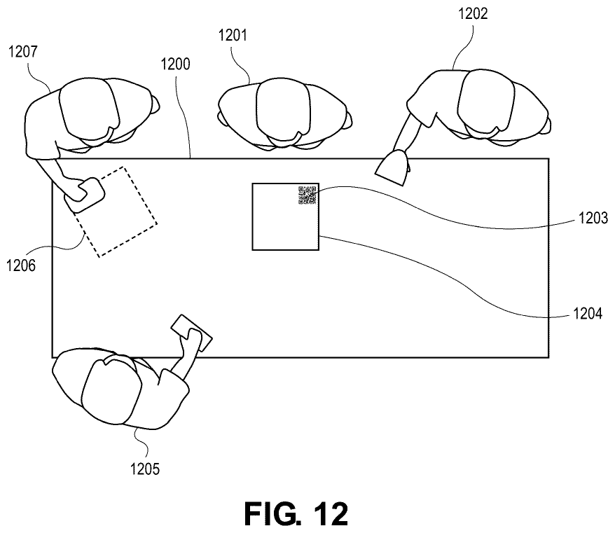

Referring to FIG. 12, an overhead pictorial view of a four-person, high-throughput system and apparatus for authenticating signed items is shown. This configuration may be the same or similar as the configuration shown in FIG. 11, however, if a table-mounted camera for capturing video is not available, a fourth person 1205 can capture video of the signing with a phone or other video recording device.

In the system for authenticating signings, it is contemplated that the end consumer may interact with the tagged item they purchased. For example, the end user/consumer may scan a QR code or read an NFC tag with their phone and be directed to a webpage that displays the authentication video. The webpage may display other content related to the signing, the participant that signed the item, etc. Furthermore, it is contemplated that the end user/consumer may “claim” or “register” the signed item they purchased. For example, the end user/consumer may scan a QR code or read an NFC tag and be prompted to provide basic details to claim or register the item (e.g., name, phone number, etc.)

One potential problem with this registration process is the idea that bad actors could falsely register and claim ownership of items they did not purchase. For example, if a memorabilia shop has inventory of pre-tagged items and an employee of the shop claims ownership of items the employee did not purchase. To address this issue, it is contemplated that certain measures could be put in place. For example, by using the code on each item, a system could be put in place whereby an item may be “unregisterable” until authenticated. Another potential problem is there may be instances where items are authenticated and held in inventory but not yet sold. To address this issue, a system could be put in place, using the code on each item, whereby an item may be unregisterable until the purchase is complete. When an end user/consumer purchases a signed item, and registers the item by providing basic information (e.g., name and phone number) it is contemplated that the system can send the end user a code to the phone number provided, and the end user may be required to enter this code to complete the registration process.

Referring to FIG. 13, a block diagram of an example computing device that may perform one or more of the method operations described herein is shown in accordance with some embodiments. More particularly, computing device 1300 may be integrated in any of the servers and/or devices described above to perform any of the described operations. Computing device 1300 may be connected to other computing devices in a LAN, an intranet, an extranet, and/or the Internet. The computing device may operate in the capacity of a server machine in the client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1300 may include one or more processors (e.g., a processing device, a general purpose processor, a PLD, etc.) 1302, a main memory 1304 (e.g., synchronous dynamic random access memory (DRAM), read-only memory (ROM)), a static memory 1305 (e.g., flash memory and a data storage device 1318), which may communicate with each other via a bus 530.

The one or more processors 1302 may be provided by one or more general-purpose processing devices such as a microprocessor, central processing unit, or the like. In an illustrative example, processor(s) 1302 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor(s) 1302 may also comprise one or more special-purpose processing devices such as an application specific integrated circuit (ASIC), a field programmable gate array (FPGA), a digital signal processor (DSP), network processor, or the like. The processor(s) 1302 may be configured to execute the operations described herein, in accordance with one or more aspects of the present disclosure, for performing the operations and steps discussed herein.

Computing device 1300 may further include a network interface device 1308 which may communicate with a network 1309. The computing device 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse) and an acoustic signal generation device 1315 (e.g., a speaker). In one embodiment, video display unit 1310, alphanumeric input device 1312, and cursor control device 1314 may be combined into a single component or device (e.g., an LCD touch screen).

Data storage device 1318 may include a non-transitory computer-readable storage medium 1328 on which may be stored one or more sets of instructions 1325 that may include instructions for carrying out the operations described herein, in accordance with one or more aspects of the present disclosure. Instructions 1325 may also reside, completely or at least partially, within main memory 1304 and/or within processor(s) 1302 during execution thereof by computing device 1300, main memory 1304 and processor(s) 1302 also constituting computer-readable media. The instructions 1325 may further be transmitted or received over a network 1309 via network interface device 1308.

While computer-readable storage medium 1328 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

The use of a mobile device (e.g., smartphone) to authenticate the signing of an item affords the benefits described herein. However, in certain circumstances, it is contemplated that an apparatus or apparatuses may be helpful to improve the throughput of a signing event. Often signing events involve celebrities with limited time, and there may be many items to sign, so the speed at which the signer/participant can sign items is important. The foregoing are various configurations and combinations of systems, apparatuses, and methods to accommodate various circumstances, including the number of individuals required to authenticate, the speed required, and the amount and type of equipment required to authenticate items being signed.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
capturing, by one or more cameras of an authentication system, a first image of a unique code on a physical item at a first time of a session;
capturing, by the one or more cameras, a second image of a participant affixing a signature to the physical item during the session;
capturing, by the one or more cameras, a third image of the signature and the unique code on the physical item at a second time of the session; and
generating, by one or more processors of the authentication system, an authentication asset including the unique code superimposed on one or more of the first image, the second image, or the third image.

2. The method of claim 1 further comprising:
generating, by the one or more processors, session data representing the session, wherein the session data includes one or more of time data or location data associated with the session; and
wherein the authentication asset includes the session data superimposed on the one or more of the first image, the second image, or the third image.
